(19) United States
(12) Patent Application Publication
(10) Pub. No.: US 2024/0418298 A1
(43) Pub. Date: Dec. 19, 2024

(54) Modular Conduit Routing and Support System

(71) Applicant: Cody Titus, Prineville, OR (US)

(72) Inventor: Cody Titus, Prineville, OR (US)

(21) Appl. No.: 18/642,533

(22) Filed: Apr. 22, 2024

Related U.S. Application Data
(60) Provisional application No. 63/460,708, filed on Apr. 20, 2023.

(51) Int. Cl. F16L 3/223; F16L 3/12

(52) U.S. Cl. CPC F16L 3/223; F16L 3/12

(57) ABSTRACT

A conduit routing and support system is provided which supports conduits upon a mounting surface. Each conduit is supported within a slot formed in a body which is engageable to the mounting surface. Each body is configured to engage with an adjacent body supporting an adjacent conduit in a rack. Conduit retainers are configured to maintain the conduits within a respective slot and each adjacent body in the rack may have a body retainer to hold the adjacent bodies in a formed rack engaged.

### FIELD OF THE INVENTION

The present device relates to elongated conduit and piping systems and the like. More particularly, the disclosed device and system relate to a modular assembleable routing and support system of such conduits and pipe.

### BACKGROUND OF THE INVENTION

In modern construction of both homes and commercial buildings, the supported positioning and the routing of conduits for electrical wires and for pipe employed to provide water and other fluids is a time consuming yet important task. In the field of electrical conduit positioning and routing in buildings, professional electricians must follow building codes which have both support requirements as well as routing requirements for the conduit. Where pipe for plumbing is involved, plumbers must also employ professional workmanship to support the pipe placed upon and within the building.

While this specification employs the term “conduit” for the ease of description, such use is meant to include rigid metallic conduits, flexible metal conduits, non-metal liquid-tight flexible and rigid pipe or conduit, non-metallic electrical tubing, rigid and flexible polymeric conduit and tubing, and other forms of tube, pipe, or conduit, which conventionally is employed in either or both of homes and commercial structures.

Conventionally, professionals, as well as do-it-yourself homeowners, employ conduit and pipe for the noted variety of functions herein. During original construction and remodeling, such conduit and pipe must be routed, assembled, and supported once in a final position. The support of conventional conduit and pipe is generally accomplished using nail straps, conduit straps, screws, plumber's tape, nail-engaged fittings, and a wide variety of individual conduit and pipe supports.

As can be discerned, such individual supports are positioned per building code and more frequently at the whim and decision of the installer. Further, they provide no real manner to help determine routing of the conduit or piping within the building.

The forgoing background concerning conventional conduit and pipe systems and some of the limitations related therewith are intended to be illustrative and not exclusive, and they do not imply any limitations on the modular assembleable conduit and pipe support system and invention described and claimed herein. Various other limitations of the related art of supporting and routing and supporting conduit and pipe are known or will become apparent to those skilled in the art upon a reading and understanding of the specification below and the accompanying drawings.

It is an object of this invention to provide a system for the mounted support and routing of conduit and pipe systems in and on buildings.

It is a further object of this invention to provide such a conduit support and routing device and system which is formed of individual assembleable components.

It is yet another object of this invention to provide such assembleable support components which are engageable to each other, such as in a tongue and groove removable engagement.

It is a further object of this invention to provide a system which is assembleable to both support conduits and pipes, as well as for positioning, to delineate routing for pipe and conduit and positioning, as well as operative positioning for through-wall penetrations thereof.

These and other objects, features, and advantages of the present modular conduit and pipe support and routing system herein, as well as the advantages thereof over existing prior art, which will become apparent from the description to follow, are accomplished by the improvements described in this specification and hereinafter described in the following detailed description which fully discloses the invention, but should not be considered as placing limitations thereon.

### SUMMARY OF THE INVENTION

The device and system herein provides a modular assembleable support system for conduits and other pipe and tubing used widely in both commercial and home construction and remodeling. The system employs a substantially U-shaped body having a substantially centered slot formed therein which communicates with an opening at a first end of the body. The body is preferably formed of elastic flexible material which will allow the legs on opposite sides of a slot to flex and then return to the prior position upon insertion of a conduit into the slot. The slot is preferably configured with a diameter equal to or slightly larger than the exterior diameter of a conduit or a pipe to be positioned within the slot. The body may be formed of polymeric or other non-metallic elastic material or may be formed of metal with sufficient flex to allow for the slot to temporarily enlarge.

Each body is configured with a slot running along a first side edge thereof and with an elongated projection extending from a second side edge thereof opposite the first side edge. The projection is sized to slide or snap into what is known as a tongue and groove engagement, with the slot formed in an adjacent body. A plurality of bodies, thus, may be assembled to form a modular elongated support rack, which has a plurality of bodies removably engaged and aligned in the same plane and which has a plurality of slots providing operatively spaced and aligned pathways for conduit or pipe.

The modular construction allows for the formation of a support rack which will provide support for varying sized conduits and pipes. As noted, the term conduit is used herein for convenience but means any pipe or conduit, such as for fluid or electrical wires or gas of any diameter, for which the slot is sized to slidably engage upon. For example and in no way limiting, a body with a substantially ½ inch diameter slot may be engaged to an adjacent body with a ¾ inch diameter slot, which may be engaged to an adjacent body having a 1 inch diameter slot. This provides for a highly adaptable system which allows for the aligned support of three sizes of conduit or tubing horizontally or vertically on a wall or other structure.

Preferably, within each slot is positioned a magnet. This is most preferred in that it allows the body of the device to hold itself in position upon a metallic conduit. In this magnetically engaged position, the user is provided a hands-free support of the body, operatively engaged with the conduit within the slot, while they proceed to connect the body, or a plurality thereof forming a rack to a wall or to a conventional unistrut or the like.

Also provided on the body of the device herein are one or a plurality of passages communicating through the body. A first of these passages may be positioned to be employed as a drill guide for a pilot hole. To that end, one side of the body is placed in contact with the wall or mount, wherein the user may employ a drill communicating through the first passage to form or mark a pilot hole. Where the body is formed of polymeric material, a metal sleeve would be positioned in this first passage.

A second passage, smaller than the first, may also be provided which communicates through the body of the device. This smaller passage is positioned on-center with the axis of the slot and where a conduit will terminate into an electrical panel (such as a breaker panel or other equipment) when the spacer is placed against a wall. This positioning of the first and second passages, in alignment with the center axis of the slot, allows for the layout or marking of conduit positioning, where a hole saw or knockout tool is used to provide communication into a conduit connector for an electric panel.

Where an installer must define pathways and bends along those pathways for a series of conduits, the device herein, when assembled into racks to accommodate a plurality of conduits therethrough, is employable to lay out the conduit system before installation. A series of assembled racks, from the tongue and groove engaged bodies, when mounted on a wall adjacent power supply or fuse boxes, allows the user to define pathways for each respective conduit from such an electrical box, in parallel positioning with other conduits, in their respective path to another point in the system. Each rack may be operatively positioned on a wall or surface with the appropriate slots formed in adjacent racks aligned. Thereafter, the user can measure distances to assemble conduits for the determined pathways and to form appropriate bends therein as needed.

Additionally provided, in the body of the device of the system herein, are gauges or measurement markings along the perimeter edges of the body surrounding the slot. Such will allow the user to employ the measurement markings during assembly of racks and the system herein.

While the modular conduit routing and support system herein is being described in detail, it is to be understood that the invention is not limited in its application to the details of construction and/or to the arrangement of the steps in the system in the following description or illustrated in the drawings.

The modular assembleable conduit support and routing system herein, is capable of other embodiments and of being practiced and carried out in various ways which will become obvious to those skilled in the art on reading this disclosure. Also, it is to be understood that the phraseology and terminology employed herein are for the purpose of description and should not be regarded as limiting.

As such, those skilled in the art will appreciate that the conception upon which this disclosure is based, may readily be utilized as a basis for other such systems employing engageable bodies adapted for conduit support and routing. It is important, therefore, that the claims herein be regarded as including such equivalent construction and methodology for such insofar as they do not depart from the spirit and scope of the present invention.

As used in the claims to describe the various inventive aspects and embodiments, “comprising” means including, but not limited to, whatever follows the word “comprising”. Thus, use of the term “comprising” indicates that the listed elements are required or mandatory, but that other elements are optional and may or may not be present. By “consisting of” is meant including, and limited to, whatever follows the phrase “consisting of”. Thus, the phrase “consisting of” indicates that the listed elements are required or mandatory, and that no other elements may be present. By “consisting essentially of” is meant including any elements listed after the phrase, and limited to other elements that do not interfere with or contribute to the activity or action specified in the disclosure for the listed elements. Thus, the phrase “consisting essentially of” indicates that the listed elements are required or mandatory, but that other elements are optional and may or may not be present depending upon whether or not they affect the activity or action of the listed elements. The term “substantially”, unless otherwise specifically defined, means plus or minus five percent.

These and other objects, features, and advantages of the modular assembleable conduit support and routing system as disclosed herein, as well as the advantages thereof over existing prior art, will become apparent from the description to follow. Such are accomplished by the improvements described in this specification and hereinafter described in the following detailed description which fully discloses the conduit support and routing system herein, but should not be considered as placing limitations thereon.

### BRIEF DESCRIPTION OF DRAWING FIGURES

The accompanying drawings, which are incorporated herein and form a part of the specification, illustrate some, but not the only or exclusive examples of embodiments and/or features of the disclosed modular and assembleable conduit support and routing system. It is intended that the embodiments and figures disclosed herein are to be considered illustrative of the assembleable conduit support system invention herein, rather than limiting in any fashion.

In the drawings:

FIG. 1 depicts a first perspective view of a front side of the body of the assembleable conduit support system herein.

FIG. 2 shows an opposite or rear side view of the body of the conduit support of FIG. 1.

FIG. 3 shows the device, as in FIGS. 1-2, being assembled in respective tongue and groove engagements to form racks having a plurality of slots therein sized to provide support of and to define pathways for a plurality of lengths of conduit or pipe.

FIG. 4 shows the assembled support of FIG. 2, operatively engaged to a wall or a structure such as a conventional unistrut, to both support conduits and define respective pathways for individual conduits.

FIG. 5 depicts another view of the device of FIGS. 1 and 2 being assembled to form support racks which both support and define pathways for conduits on and through a wall or the like.

FIG. 6 shows another especially preferred mode of the device of FIGS. 1-2 where the body has a slot sized for a larger conduit, such as four inches, wherein shoulders project within the slot to form a conduit retainer to maintain a conduit within the slot.

FIG. 7 shows the device, as in FIG. 6, from a perspective view and also depicts the elongated projection sized for engagement into a recess on an adjacent slotted body.

FIG. 8 shows a side view of the device, as in FIG. 6, showing the elongated recess sized for removable engagement with the projection of an adjacent device body.

FIG. 9 depicts a second side view of the body of the device of FIG. 6 showing the elongated projection with tapered ends.

FIG. 10 shows the body of the device, as in FIGS. 1-2 and 6, formed for a smaller diameter conduit, such as one-half inch diameter.

FIG. 11 depicts a front view of the body of the device, as in FIG. 10.

FIG. 12 shows a perspective view of the body of the device of FIG. 10 showing the elongated recess sized for engagement to the projection and showing notches which align with and removably engage ribs on the projection to hold the engaged bodies in position.

### DETAILED DESCRIPTION OF THE INVENTION

In this description, the directional prepositions of up, upwardly, down, downwardly, front, back, top, upper, bottom, lower, left, right, first, second, and other such terms refer to the device and assembled support system produced thereby, as it is oriented and appears in the drawings and all such terms are used for convenience only and such are not intended to be limiting or to imply that device has to be used or positioned in any particular orientation.

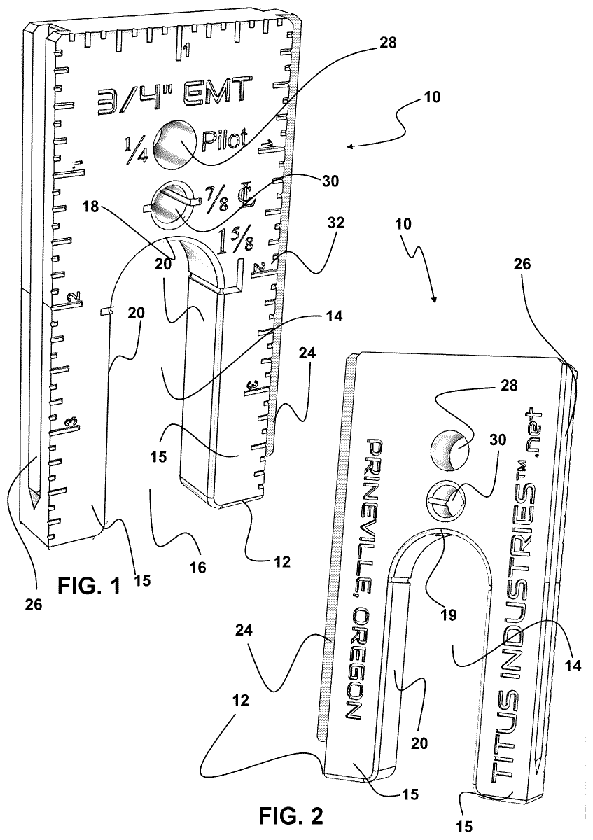

Now referring to drawings in FIGS. 1-12, there is seen in FIGS. 1 and 2 perspective views of the body 12 of the device 10 for routing and holding conduits herein from a front side view thereof. In the system herein, each body 12 has a slot 14 formed therein between two legs 15 of the body 12. The slot 14 communicates at a first end of the slot 14 with an opening 16 located in between the legs 15 at a first end of the body 12. The slot 14 runs along a center axis of the body 12, preferably, to a second end of the slot 14 at an endwall 18. The slot 14 has opposing sidewalls 20 on each leg 15 which define a diameter of the slot 14.

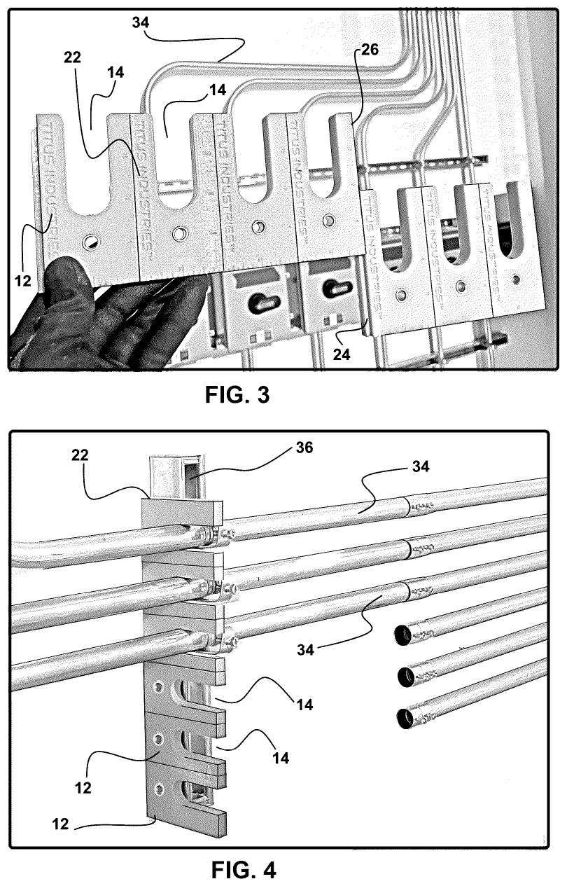

As noted, each body 12 in the system herein is formed to be removably engageable to an adjacent body 12 to form a support rack 22 as shown in FIG. 3-4. Currently, the preferred connector to engage one body 12 to an adjacent body 12 employs a projection 24 extending from a first side edge of the body 12. In all configurations, this projection 24 on one body 12 is engageable with a recess 26 formed into the second side edge of the body 12 opposite the first side edge. This sliding engagement allows for multiple bodies 12 to be connected to each other side-by-side to form a rack 22. In the formed rack 22 configuration, the slots 14 of each adjacent body 12 portion of the rack 22 can be sized to either engage over a single size of conduit 34 (FIG. 4) or engage with a mix of different sized conduits 34.

The body 12 in the system and device 10 herein, thus, can be formed in a kit of bodies 12 having multiple differently sized slot 14 configurations wherein each configuration has a slot 14 sized substantially equal to or slightly larger than the exterior diameter of the conduit 34 to be placed therein. Indicia positioned upon the surface of each such body 12 may be provided to allow a user to easily identify the size of the conduit 34 for which the slot 14 is dimensioned to engage.

Additionally shown in FIG. 2 is a conduit retainer in the form of a magnet 19 which is recessed in position along the sidewall 20 or endwall 18 at or adjacent the endwall 18. As noted, the magnet 19 is particularly helpful to hold the body 12 or the formed rack 22 in place and render it hands free during mounting. However, the positioning of a conduit retainer within the slot 14 is another especially preferred manner to hold the conduit 34 within the slot 14.

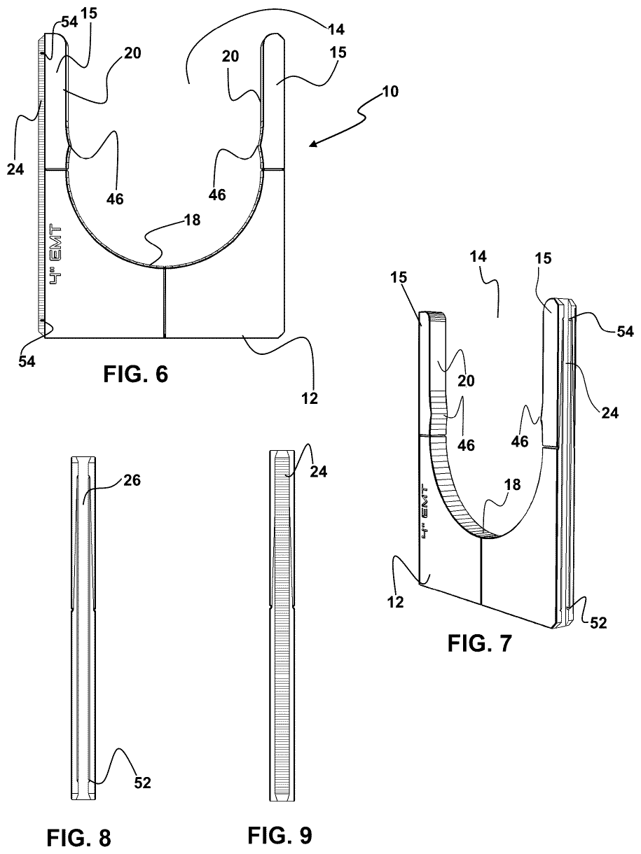

Currently, such a conduit retainer is provided in the form of at least one and preferably two opposing shoulders 46 (FIG. 6) projecting from one or both sidewalls 20 of both legs 15 within the slot 14. By positioning two shoulders 46 aligned and across from each other, the diameter of the slot 14 is made slightly smaller. Once a conduit 34 is inserted into the slot 14, the opposing legs 15 on opposing sides of the slot 14 will momentarily flex in opposite directions and allow the conduit to pass through the narrowed slot 14 at the shoulders 46. Once passed therethrough, the body 12 is held to the conduit 34 by the conduit retainer in the form of the two shoulders 46 narrowing the diameter of the slot 14.

Also shown in FIGS. 1 and 2 are a first passage 28 which communicates between the front surface and rear surface of the body 12. While not required for the overall function of the device 10, this first passage 28 is sized for use as a drill pilot hole and may have a circumference which is formed of metal or drill-resistant material. Preferably, the first passage is in alignment with the center axis of the slot 14. A second passage 30 running in alignment with the first passage may also be provided for marking or drilling.

Additionally shown and preferred are measurement indicia 32 along the perimeter edge of the body 12. This allows the user to make measurements for marking pathways and connection points for conduit 34 which, as noted above, means any type of pipe or conduit whether from gas, fluid, or electrical or routing for other types of service.

As noted, in FIGS. 3 and 4 are a plurality of bodies 12 operatively connected to each other to form a rack 22. As shown, each body 12 provides a separate support and pathway for a separate conduit 34 or the like. Currently, the preferred mode for engagement of adjacent bodies 12 are the tongue and groove connection between the projection 24 on a leg 15 of one body 12 to the recess 24 formed into the leg 15 of the other body 12. The racks 22 may be engaged using conventional fasteners, such as screws or other fasteners as would be employed by those skilled in the art, to the wall or mounting surface. For example, a widely employed conventional mount is a unistrut 36. However, any fastener which will hold a body 12 or support rack 22 of engaged bodies 12 of one or different sizes may be employed. Preferably, the overall width of the bodies 12 and the respective slot 14 in each are sized to frictionally engage upon the sized conduit 34 to be used.

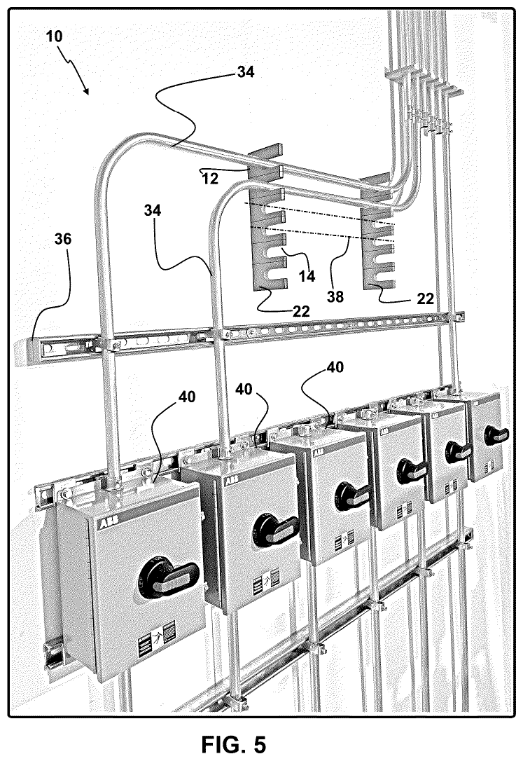

Another view of the system herein using pluralities of bodies 12 operatively engaged to form racks 22 is shown in FIG. 5. As depicted, the positioning of the rack 22 in engagements with first-positioned conduits 34 allows the user to define pathways 38 along which other conduits may be positioned and to easily calculate bend points or turns in such conduits 34 which may be required to reach power supply boxes 40. The width of the body 14, as well as the size of the slot 14 therein, are preferably configured to also maintain an even or substantially equal spacing between the conduits 34 when the conduits 34 are of equal size. However, the user may also mount the bodies 12, as needed, for desired spacing.

In FIGS. 6-9 are shown another especially preferred mode of the device 10 which is shown configured for a larger diameter conduit 34 than that of FIGS. 1-2. In this preferred configuration, shoulders 46 project within the slot 14 formed between the legs 15 of the body 12 and form the conduit retainer to maintain a conduit 34 within the slot 14. As with the other shown bodies 12 herein, the elongated recess 26 is sized for removable engagement with the projection 24 of an adjacent device body 12.

Also shown in FIG. 9, the elongated projection 24 has tapered ends for easier engagement within a recess 26.

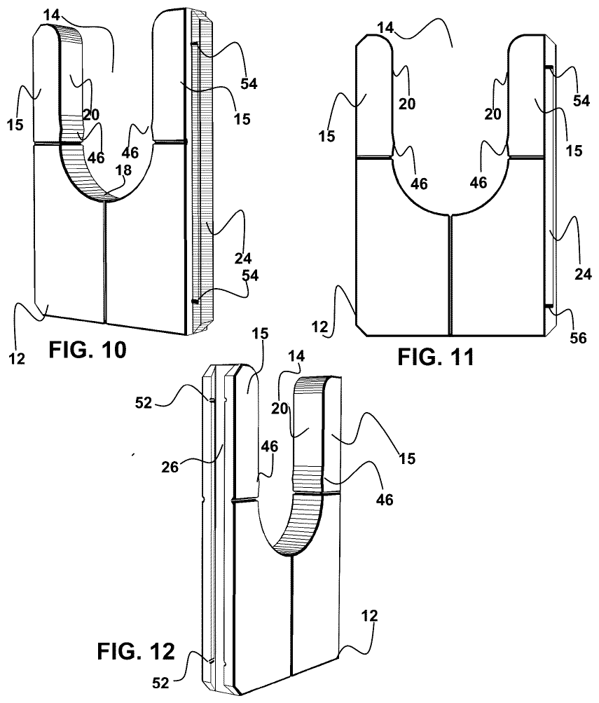

In FIGS. 10-12 is shown a body 12 of the device and system herein, similar to that of FIGS. 1-2 and 6 but having a slot 14 sized for removable engagement with a smaller diameter conduit 34. Also preferred in the device and system herein is a retainer for holding the projection 24 on one body 12 engaged with a recess 26 formed into an adjacent body 12 engaged thereto. Currently, such a retainer is shown as notches 52 which are positioned within the recess 26 to align with and removably engage with ribs 54 projecting from side surfaces of the projection 24 of the adjacent body 12 in a rack formation. The engaged ribs 54 within the notches 52 serve to retain the adjacent engaged bodies 12 in position with each other until a user exerts sufficient sliding force to disengage them. The retainer may be other connections formed between the two adjacent bodies 12 as would occur to one skilled in the art.

As noted, any of the different configurations and components of the conduit support system shown and described herein, or the steps in determining the optimum configuration thereof can be employed with any other configuration or component shown and described. Additionally, while the disclosed modular conduit routing and support system herein has been described herein with reference to particular embodiments thereof and components thereof operatively engaged for operation, a latitude of equivalent modifications, various changes and substitutions are intended in the foregoing disclosures and it will be appreciated that in some instance some features, or configurations, or operations of the invention could be employed without a corresponding use of other features, without departing from the scope of the invention as set forth in the following claims. All such changes, alternations, and modifications for a substantially equivalent structure or system as would occur to those skilled in the art subsequent to reviewing this specification are considered to be within the scope of this invention as broadly defined in the appended claims.

Further, the purpose of any abstract of this specification is to enable the U.S. Patent and Trademark Office, the public generally, and especially the scientists, engineers, and practitioners in the art who are not familiar with patent or legal terms or phraseology, to determine quickly from a cursory inspection the nature and essence of the technical disclosure of the application. Any such abstract included herein is neither intended to define the invention of the application, which is measured by the claims, nor is it intended to be limiting, as to the scope of the invention in any way.

What is claimed is:

1. A conduit routing and support apparatus, comprising:
a first body formed of flexible material;
a slot formed into a first end of said first body, said slot positioned between opposing sidewalls formed on two legs of said first body, said slot extending from an open end at said first end of said first body to an endwall;
said slot for positioning a first conduit therein;
said slot having a diameter between said opposing sidewalls thereof which is sized equal to or slightly larger than said first conduit;
a projection extending from a first side edge of said first body;
a recess formed into a second side edge of said first body;
and said first body engageable to a mounting surface with a fastener to a mounted position, supporting said first conduit within said slot thereof.

2. The conduit routing and support apparatus of claim 1 additionally comprising:
a second body formed of said flexible material;
said second body having a slot formed into a first end thereof, said slot positioned between opposing sidewalls formed on two legs of said second body, said slot extending from an open end at said first end of said second body to an endwall;
said slot in said second body for positioning a second conduit therein;
said slot in said second body having a diameter between said opposing sidewalls thereof which is sized equal to or slightly larger than said second conduit;
a projection extending from a first side edge of said second first body; and
said projection engageable with said recess formed into said second side edge of said first body to form a rack supporting said first conduit within said slot in said first body and supporting said second conduit within said slot formed into said second body.

3. The conduit routing and support apparatus of claim 2 additionally comprising:
a body retainer holding said second body to said first body with said projection on said first body engaged within said recess formed in said second body.

4. The conduit routing and support apparatus of claim 3 wherein said body retainer comprises:
notches formed into said recess formed in said second body; and
ribs positioned on said projection on said first body which engage with said ribs.

5. The conduit routing and support apparatus of claim 1 additionally comprising:
a conduit retainer for holding said first conduit within said slot.

6. The conduit routing and support apparatus of claim 5 wherein said conduit retainer comprises:
a magnet.

7. The conduit routing and support apparatus of claim 5 wherein said conduit retainer comprises:
a first shoulder positioned on one of said pair of sidewalls across from a second shoulder positioned upon a second of said pair of sidewalls.

8. The conduit routing and support apparatus of claim 4 additionally comprising:
a conduit retainer for holding said first conduit within said slot.

9. The conduit routing and support apparatus of claim 8 wherein said conduit retainer comprises:
a magnet.

10. The conduit routing and support apparatus of claim 8 wherein said conduit retainer comprises:
a first shoulder positioned on one of said pair of sidewalls across from a second shoulder positioned upon a second of said pair of sidewalls.
